(19) United States
(12) Patent Application Publication
(10) Pub. No.: US 2021/0270600 A1
(43) Pub. Date: Sep. 2, 2021

(54) SYSTEM AND METHOD

(71) Applicant: Kabushiki Kaisha Toshiba, Tokyo (JP)

(72) Inventors: Kentaro YOSHIOKA, Kawasaki Kanagawa (JP); Hidenori Okuni, Yokohama Kanagawa (JP); Akihide Sai, Yokohama Kanagawa (JP)

(73) Assignee: Kabushiki Kaisha Toshiba, Tokyo (JP)

(21) Appl. No.: 17/014,757

(22) Filed: Sep. 8, 2020

(30) Foreign Application Priority Data
Feb. 27, 2020 (JP) 2020-031239

(51) Int. Cl. G01B 11/14; G01B 11/25; B25J 9/16

(52) U.S. Cl. CPC G01B 11/14; B25J 9/1697; G01B 11/2518

(57) ABSTRACT

A system includes a distance measurement apparatus to emit a first light in a first direction toward an object or a second light in a second direction different from the first direction toward a reflection member, and to measure a distance to the object in accordance with a first reflected light provided by a reflection of the first light on the object or a second reflected light provided by reflections of the second light, a position detector configured to detect a position of the object based on the distance; and a light direction controller to determine whether an obstacle exists on an optical path of the first direction, to control the distance measurement apparatus to emit the first light in the first direction, when the obstacle does not exist, and to control the distance measurement apparatus to emit the second light in the second direction, when the obstacle exists.

### CROSS REFERENCE TO RELATED APPLICATIONS

This application is based upon and claims the benefit of priority from the prior Japanese Patent Application No. 2020-31239, filed on Feb. 27, 2020, the entire contents of which are incorporated herein by reference.

### FIELD

Embodiments of the present invention relates to a system and a method.

### BACKGROUND

Robots have been introduced to production sites to automate production. For example, to assemble an object with robot arms, the position of the object needs to be accurately detected. For this purpose, a robotic vision system that receives reflected light of the light emitted to the object and identifies the position of the object has been proposed.

The robotic vision has been designed to receive the reflected light in response to direct light emitted to the object. However, if an obstacle such as a robot arm exists in an optical path along which the direct light propagates, the direct light is not able to reach the object, and the position of the object cannot be accurately specified.

In order to eliminate such blind spots, a number of sensors that detect the distance to the object in a non-contact manner may be disposed to locate the object by considering the detection information of each sensor comprehensively, but this would require a large number of sensors and thus increase the equipment cost. Another possibility is to place a sensor at the tip end of the robot arm that can change the direction of light, but this sensor would take a long time to scan the light and reduce the work efficiency of the robot.

### BRIEF DESCRIPTION OF THE DRAWINGS

FIG. 1 is a block diagram illustrating a schematic configuration of a system according to a first embodiment;

FIG. 2 is a diagram for explaining first light and second light;

FIG. 3 is a flowchart illustrating a processing operation of the system according to the first embodiment;

FIG. 4 is a block diagram of the system illustrated in FIG. 1 to which a first optical scanning unit and a second optical scanning unit are added;

FIG. 5 illustrates a positional relationship between the position of the distance measurement device and the object;

FIG. 6 illustrates a relationship between the position of the distance measurement device, the position of a reflecting surface of a reflecting member, the position of the object, and the position of a virtual image;

FIG. 7 illustrates a positional relationship between the distance measurement device, the reflecting member, and the object during indirect sensing;

FIG. 8A illustrates an example in which a reflecting member is provided in the distance measurement device;

FIG. 8B illustrates an example in which the reflecting member is also provided inside the distance measurement device;

FIG. 9 is a flowchart illustrating the processing operation of the system according to a second embodiment;

FIG. 10 is a diagram for explaining a technical characteristic of a system according to a third embodiment;

FIG. 11 is a diagram for explaining a technical characteristic of a system according to a fourth embodiment;

FIG. 12 is a block diagram illustrating a first example of the distance measurement device; and

FIG. 13 illustrates a second example of the distance measurement device.

### DETAILED DESCRIPTION

According to one embodiment of a system, including:

a distance measurement apparatus configured to emit a first light in a first direction toward an object or a second light in a second direction different from the first direction toward a reflection member, and to measure a distance to the object in accordance with a first reflected light provided by a reflection of the first light on the object or a second reflected light provided by reflections of the second light on both the reflection member and the object;

a position detector configured to detect a position of the object in accordance with the distance; and

a light direction controller configured to:
determine whether an obstacle exists on an optical path of the first direction;
control the distance measurement apparatus to emit the first light in the first direction, when the obstacle does not exist on the optical path; and
control the distance measurement apparatus to emit the second light in the second direction, when the obstacle exists on the optical path.

Embodiments of a system will be described below with reference to the accompanying drawings. Although the following description will focus on the major constituent components of the system, there may be constituent components and functions in the system that are not illustrated or described. The following description does not exclude any constituent components or functions not illustrated or described herein.

### First Embodiment

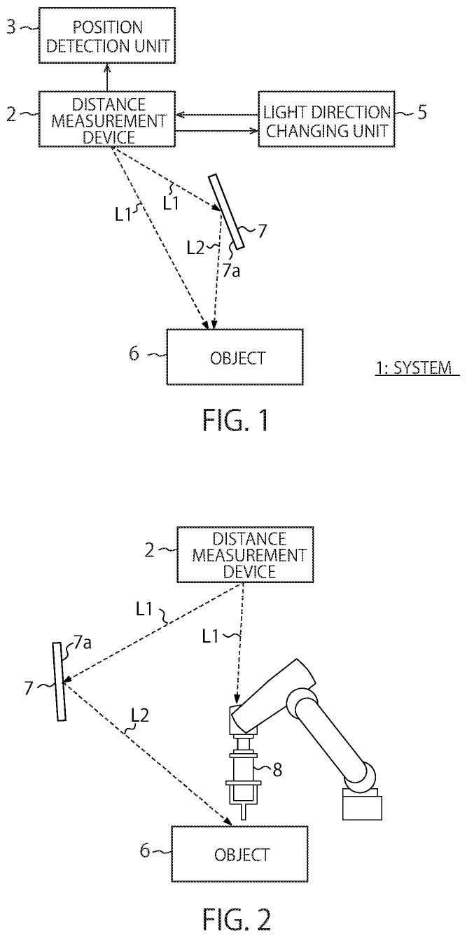

FIG. 1 is a block diagram illustrating a schematic configuration of a system 1 according to a first embodiment. A system 1 of FIG. 1 has a function of optically detecting the position of an object in a non-contact manner. The object can be any type of object, for example, an object to be grasped or processed by a robot arm.

The system 1 of FIG. 1 includes a distance measurement device 2, a position detecting unit (position detector) 3, and a light direction changing unit (light direction controller) 5.

The distance measurement device 2 measures the distance to the object 6 in accordance with reflected light of the light emitted to the object 6. That is, the distance measurement device 2 emits a first light in a first direction toward an object or a second light in a second direction different from the first direction toward a reflection member, and measures a distance to the object in accordance with a first reflected light provided by a reflection of the first light on the object or a second reflected light provided by reflections of the second light on both the reflection member and the object. A typical example of the distance measurement device 2 is a device using a time of flight (ToF) method or a pattern projection method. An example of a device that uses the ToF method is a light detection and ranging (LiDAR) device. A device using the pattern projection method is referred to as a pattern projection device in the present specification. The outline of the LiDAR device and the pattern projection device will be described later. The distance measurement device 2 may perform distance measurement using light according to an operation principle other than the LiDAR device or the pattern projection device.

The position detecting unit 3 detects the position of the object 6 in accordance with the distance measured by the distance measurement device 2. For example, the position detecting unit 3 detects a three-dimensional coordinate position of the object 6. A specific method for detecting the position of the object 6 will be described later. The position detecting unit 3 may include a virtual image determining unit and a real image conversion unit. The virtual image determining unit determines whether the position of the object 6 detected by the position detecting unit 3 is a virtual image position in accordance with the distance measured by the distance measurement device 2 and the position of the reflecting member 7. When it is determined that the position of the object 6 is the virtual image position, the real image conversion unit converts the virtual image position of the object 6 into the real image position.

A light direction controller corresponding to the light direction changing unit 5 determines whether an obstacle exists on an optical path of the first direction, controls the distance measurement apparatus to emit the first light in the first direction, when the obstacle does not exist on the optical path, and controls the distance measurement apparatus to emit the second light in the second direction, when the obstacle exists on the optical path.

The light direction changing unit 5 determines the presence or absence of an obstacle on an optical path on which the first light L1 emitted in a first direction toward the object 6 reaches the object 6 and, if the presence of the obstacle is determined, emits the second light L2 in a second direction different from the first direction to perform processing of reflecting the second light L2 by the reflecting member 7 and irradiating the object 6. The type of the obstacle is not particularly limited, but any object that reflects, refracts, or absorbs light can be used as the obstacle. Note that an object that transmits light is not included in the obstacle in the present specification. The reflecting member 7 has a reflecting surface 7a. The reflecting surface 7a preferably has a reflectance of 80% or more for the first light L1. The reflecting surface 7a may be any surface such as a wall surface of a building that reflects light. When detecting the position of the object 6, the position detecting unit 3 needs to accurately grasp the position and angle of the reflecting surface 7a of the reflecting member 7. The position and angle of the reflecting surface 7a may be determined in constructing the system 1 of FIG. 1. Alternatively, after installing the reflecting material 7, an image of the surroundings of the reflecting member 7 is photographed, and the photographed image is analyzed to recognize the position and angle of the reflecting surface 7a. Note that the light direction changing unit 5 may change the direction of the light emitted by itself, or may output the information necessary for changing the direction of the emitted light to allow other devices to change its light emitting direction.

FIG. 2 is a diagram for explaining the above-mentioned first light L1 and second light L2. FIG. 2 illustrates an example in which the position of the object 6 is detected and a robot arm 8 is moved according to the detected position. The robot arm 8 of FIG. 2 grips the object 6 or performs some processing on the object 6 in accordance with the result of detecting the position of the object 6.

It is assumed that the emitted first light L1 is emitted to the object 6 and the distance measurement device 2 in FIG. 2 receives the reflected light. However, when the robot arm 8 exists on the optical path of the first light L1, the robot arm 8 becomes the obstacle and the first light L1 is not emitted to the object 6. Therefore, in such a case, the light direction changing unit 5 changes the light emitting direction of the first light L1 and causes the reflecting member 7 to be irradiated with the light. The first light L1 applied to the reflecting member 7 is reflected to become the second light L2. The second light L2 travels in a direction different from that of the first light L1 and, more specifically, travels in a direction in which the robot arm 8 is not irradiated, and is emitted to the object 6. The light reflected by the object 6 travels in the direction opposite to the second light L2 and is reflected by the reflecting member 7, then travels in the direction opposite to the first light L1, and is received by the distance measurement device 2. Thus, by irradiating the object 6 with the second light L2 reflected by the reflecting member 7, it is possible to eliminate a blind spot when the distance measurement device 2 measures the distance of the object 6.

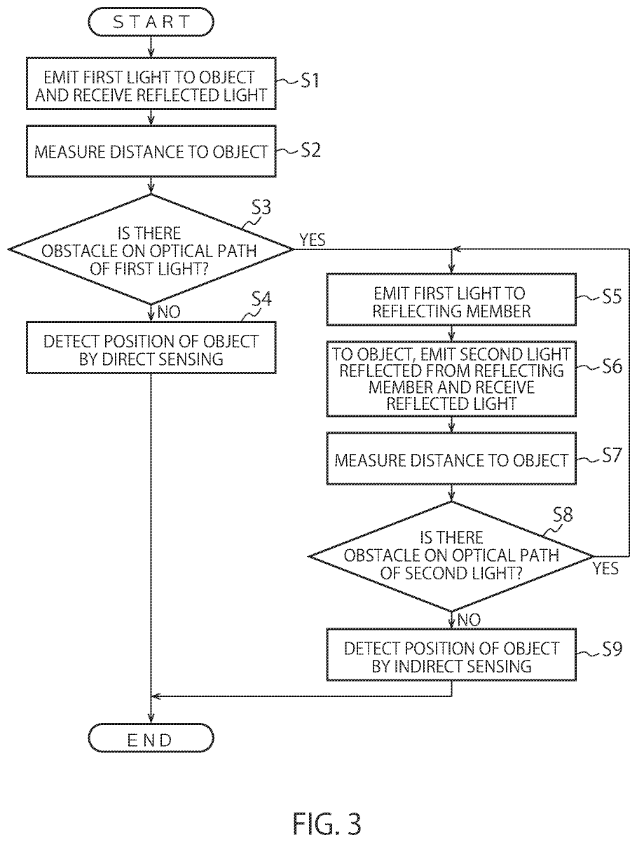

FIG. 3 is a flowchart illustrating the processing operation of the system 1 according to the first embodiment. The flowchart of FIG. 3 illustrates a processing operation for detecting the position of the object 6. The system 1 of FIG. 1 repeatedly executes the processing of the flowchart of FIG. 3, for example, when a gripping operation of the object 6 or a machining operation is performed by the robot arm 8.

First, the distance measurement device 2 emits first light L1 to the object and receives reflected light of the first light L1 reflected by the object 6 (step S1). In the present specification, the processing of step S1 is also referred to as direct sensing. Next, a distance to the object 6 is measured in accordance with the first light L1 and the received reflected light (step S2). The processing of step S2 is performed by the distance measurement device 2.

Next, in accordance with the distance measured in step S2, it is determined whether an obstacle exists on the optical path of the first light L1 from the distance measurement device 2 to the object 6 (step S3). The processing of step S3 is performed by the light direction changing unit 5. It is assumed that the light direction changing unit 5 comprehends an approximate distance to the object 6 in advance. The light direction changing unit 5 determines the presence of the obstacle when the distance measured by the distance measurement device 2 is largely different from a previously assumed distance or when the distance measurement device 2 cannot receive the second light L2. For example, if the ToF sensor determines the presence of the obstacle between the distance measurement device 2 and the object 6, the light reflected by the obstacle is received by the distance measurement device 2, and thus the light is received at the timing earlier than the expected reception timing. As a result, the light direction changing unit 5 determines the presence of the obstacle between the distance measurement device 2 and the object 6, because the measured distance is shorter than the assumed distance.

If the absence of the obstacle is determined in step S3, the position of the object 6 is detected in accordance with the distance measured by the distance measurement device 2 by direct sensing in step S2 (step S4). The position detecting unit 3 performs the processing of step S4.

When the presence of the obstacle is determined in step S3, the direction of the first light L1 emitted from the distance measurement device 2 is switched by the light direction changing unit 5, and the first light L1 is emitted to the reflecting member 7 (step S5). The first light L1 is reflected by the reflecting member 7 to become the second light L2. Since the second light L2 travels in a direction different from that of the first light L1, there is a high possibility that the second light L2 is emitted to the object 6 without being emitted to the obstacle. The reflected light reflected by the object 6 travels in the opposite direction of the second light L2 and is reflected by the reflecting member 7, and travels in the opposite direction of the first light L1 and is received by the distance measurement device 2 (step S6). In the present specification, the processing of step S6 is referred to as indirect sensing. The distance measurement device 2 measures the distance to the object 6 in accordance with the received reflected light and the original first light L1 (step S7).

Even if indirect sensing is performed, there is a possibility that the obstacle may be present on the optical path of the second light L2 reflected by the reflecting member 7. Therefore, the light direction changing unit 5 determines the presence or absence of the obstacle on the optical path of the second light L2 (step S8).

For example, if the distance measured by the distance measurement device 2 is shorter than the initially assumed distance, it is determined that the obstacle exists between the distance measurement device 2 and the object 6. If the presence of the obstacle is determined, the reflecting angle of the reflecting member 7 is changed or the irradiation position of the first light L1 on the reflecting member 7 is changed in step S5, for example, and then the processing of steps S5 to S8 is repeated. If the presence of the obstacle is determined even after the processing of steps S5 to S8 is repeated n times (n is an integer of 2 or more), the processing of FIG. 3 is stopped and the operator may be prompted to remove the obstacle.

If it is determined in step S8 that there is no obstacle, the position of the object 6 is detected in accordance with the distance measured by indirect sensing (step S9).

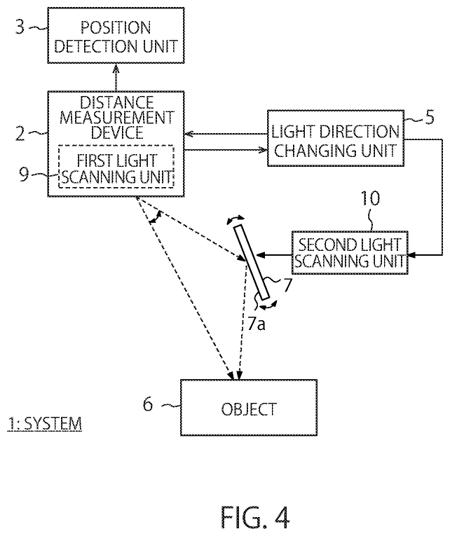

FIG. 4 illustrates the system 1 of FIG. 1 to which a first optical scanning unit 9 and a second optical scanning unit 10 are added. The first optical scanning unit 9 scans the direction of the first light L1 emitted from the distance measurement device 2 within a predetermined first angular range. The first optical scanning unit 9 can switch the direction of the first light L1 within the first angular range, and can project the first light L1 in the optimum direction within the first angular range.

When the first optical scanning unit 9 scans the direction of the first light L1 within the first angular range, the optimum direction of the first light L1 is the direction in which the object 6 can be directly irradiated.

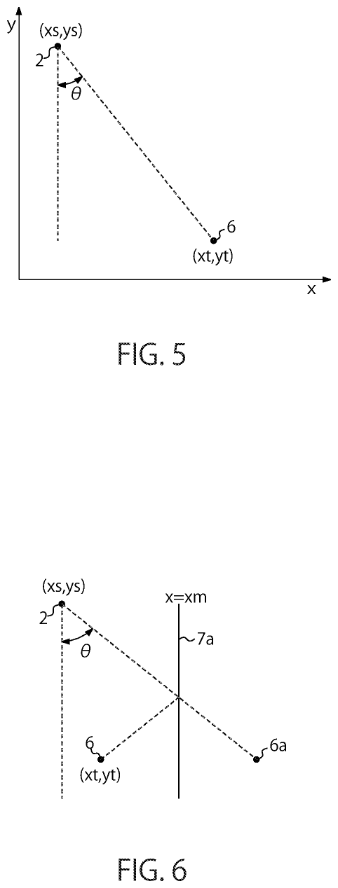

FIG. 5 illustrates a positional relationship between the position of the distance measurement device 2 and the object 6. For simplification, the distance measurement device 2 and the object 6 are disposed in a two-dimensional plane in FIG. 5. The coordinates of the distance measurement device 2 are (xs, ys), the coordinates of the object 6 are (xt, yt), and the direction from the distance measurement device 2 to the object 6 is represented by an angle θ. The angle θ is represented by the following equation (1).

$$θ = arctan ( \frac{yt - ys}{xt - xs} ) \qquad ( 1 )$$

The first optical scanning unit 9 scans the first light L1 within a first angular range having the angle represented by the equation (1) as a central angle.

The second optical scanning unit 10 scans the direction of the second light L2 reflected by the reflecting member 7 within a predetermined second angular range. The second optical scanning unit 10 can switch the direction of the second light L2 within the second angular range, and can project the second light L2 in the optimum direction within the second angular range.

FIG. 6 illustrates the relationship between the position of the distance measurement device 2, the position of the reflecting surface 7a of the reflecting member 7, the position of the object 6, that is, the position of the real image, and the position of the virtual image. As will be described later, the distance measurement device 2 irradiates the object 6 with the second light L2 reflected by the reflecting surface 7a of the reflecting member 7, and the reflected light at the irradiated position is propagated in a direction opposite to the second light L2 and reflected again by the reflecting surface 7a. The reflected light by the reflecting surface 7a propagates in the opposite direction of the first light L1 and is received by the distance measurement device 2. Thus, the distance measurement device 2 measures the distance to the object 6 in accordance with the optical path length from emission of the emitted first light L1 to the object 6 through the reflecting member 7 until reception of the reflected light through the reflecting member 7. Since the distance measurement device 2 measures the distance simply in accordance with the optical path length, the distance measurement device 2 only needs to emit the first light L1 in the same direction as if the object 6 were present at a position (virtual image position) 6a opposite the object 6 with the reflecting surface 7a of the reflecting member 7 as the symmetrical plane, and this direction is the optimal direction of the first light L1. This optimal direction is expressed by Equation (2).

$$θ = arctan ( \frac{yt - ys}{xt + 2 * xm - xs} ) \qquad ( 2 )$$

The system 1 of FIG. 4 also detects the position of the object 6 according to the flowchart of FIG. 3. However, the first optical scanning unit 9 can switch the direction of the first light L1 within the first angular range. If, therefore, there is the first light L1 in the direction in which no obstacle exists when the direction of the first light L1 is switched within the first angular range, the position of the object 6 can be detected in accordance with the distance measured by the distance measurement device 2 by direct sensing, and the need for indirect sensing can be eliminated.

On the other hand, the indirect sensing is performed if it is determined that the obstacle exists even when the direction of the first light L1 is switched within the first angular range. In this case, the second optical scanning unit 10 switches the direction of the second light L2 within the second angular range, and performs the indirect sensing by using the second light L2 in the direction in which it is determined that no obstacle exists in accordance with the distance measured by the distance measurement device 2 to detect the position of the object 6.

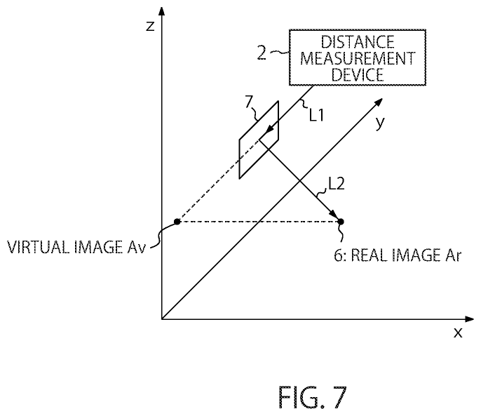

Next, the processing operation of the position detecting unit 3 when the indirect sensing is performed is described in detail. When detecting the position of the object 6 by the indirect sensing, a virtual image position such as illustrated in FIG. 7 may be erroneously detected. FIG. 7 illustrates a positional relationship between the distance measurement device 2, the reflecting member 7, and the object 6 during the indirect sensing. For simplification, FIG. 7 illustrates an example in which the reflecting member 7 is disposed on the yz-plane. The real image position in FIG. 7 represents the position where the object 6 exists. The virtual image position is a position facing the real image position with the yz-plane as a plane of symmetry.

As illustrated in FIG. 7, in the case of indirect sensing, the first light L1 emitted from the distance measurement device 2 is reflected by the reflecting member 7 to become the second light L2 and is emitted to the object 6. The reflected light from the object 6 is reflected once by the reflecting member 7 and then received by the distance measurement device 2, so that the distance measurement device 2 measures the distance to the virtual image position in FIG. 7. This may cause erroneous detection of the virtual image even by the position detecting unit 3.

Therefore, the position detecting unit 3 needs to perform processing of converting the virtual image position to the real image position when the indirect sensing is performed. When the reflecting member 7 is disposed on the yz-plane, the coordinates Av of the virtual image and a reflection conversion matrix H_{flip} for converting the virtual image into the real image are represented by Equation (3). Equation (3) is expanded to four dimensions so that the translation transformation can be expressed.

$${A}_{v} = ( \begin{matrix}{x}_{0} \\ {y}_{0} \\ {z}_{0} \\ 1\end{matrix} ) , {H}_{flip} = ( \begin{matrix}- 1 & 0 & 0 & 0 \\ 0 & 1 & 0 & 0 \\ 0 & 0 & 1 & 0 \\ 0 & 0 & 0 & 1\end{matrix} ) \qquad ( 3 )$$

The conversion of the real image into the coordinates Ar is represented by the inner product of the reflection conversion matrix and the virtual image coordinates, as illustrated in Equation (4):

$${A}_{r} = {H}_{c} {A}_{v} = ( \begin{matrix}- {x}_{0} \\ {y}_{0} \\ {z}_{0} \\ 1\end{matrix} ) \qquad ( 4 )$$

As illustrated in Equation (4), when the reflecting member 7 is disposed in the yz-plane, the coordinates of the virtual image can be converted into the coordinates of the real image only by inverting the sign of the x-axis component of the coordinates Av of the virtual image.

In practice, the reflecting member 7 can be disposed at any coordinate position. That is, the reflecting member 7 can be non-parallel to either the yz-plane, the xz-plane, or the xy-plane. In this case, after moving the coordinates of the reflecting member 7 to the yz-plane according to the transformation matrix Hₘᵢᵣᵣₒᵣ, the coordinates of the virtual image are converted to the coordinates of the real image in accordance with Equation (4) and then restored to the original coordinate system with the transformation matrix H⁻¹ₘᵢᵣᵣₒᵣ. When the series of processes is expressed by a determinant, the coordinates Ar of the real image are expressed by the following Equation (5).

Aᵣ=HₘᵢᵣᵣₒᵣH_{flip}Hₘᵢᵣᵣₒᵣ⁻¹Aᵥ (5)

If the transformation matrix Hₘᵢᵣᵣₒᵣ is derived at the time of starting up the system 1 of FIG. 1 or FIG. 4, the transformation matrix Hₘᵢᵣᵣₒᵣ which has been derived can be continuously used during the operation of the system 1, and therefore the coordinate position Ar of the real image can be easily calculated by Equation (5).

As will be described later, when the reflecting member 7 has a plurality of reflecting surfaces 7a, it is necessary to calculate the transformation matrix Hₘᵢᵣᵣₒᵣ for each reflecting surface 7a and calculate the Equation (5).

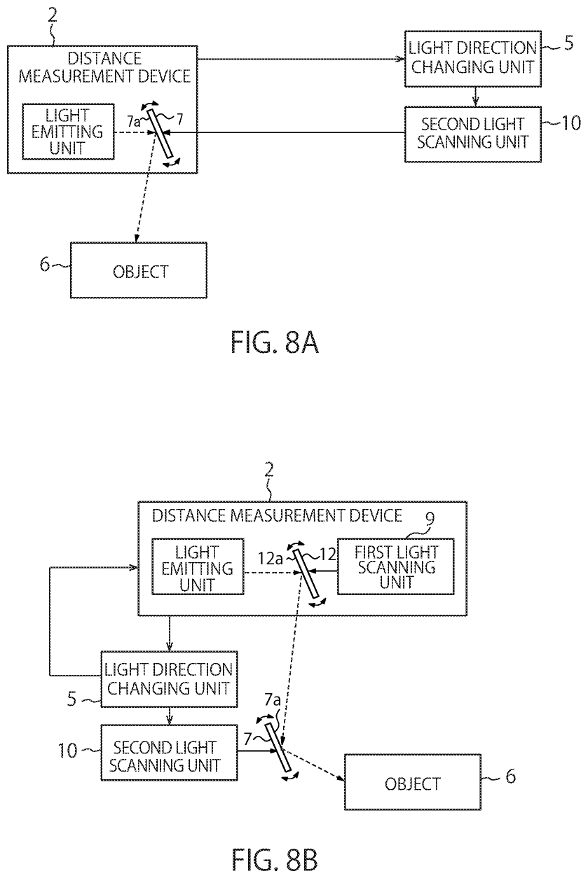

In FIGS. 1 and 4, the reflecting member 7 is provided separately from the distance measurement device 2, but the reflecting member 7 may be located inside the distance measurement device 2. FIG. 8A illustrates an example in which the reflecting member 7 is provided inside the distance measurement device 2. In the case of FIG. 8A, the direction of the first light L1 emitted from the light emitting unit 11 in the distance measurement device 2 does not change. That is, the configuration without the first optical scanning unit 9 is illustrated. The light direction changing unit 5 can change the direction of the reflecting surface 7a of the reflecting member 7, and by switching the direction of the reflecting surface 7a, the direction of the second light L2, in which the first light L1 is reflected by the reflecting surface 7a, can be switched in a second angular range.

FIG. 8B illustrates an example in which the reflecting member 7 is provided separately from the distance measurement device 2 and the reflecting member 12 is also provided inside the distance measurement device 2. The reflecting member 12 in the distance measurement device 2 can change the angle of the reflecting surface 12a according to an instruction from the first optical scanning unit 9. The light direction changing unit 5 provided separately from the distance measurement device 2 causes the second optical scanning unit 10 to change the angle of the reflecting surface 7a of the reflecting member 7. Both the reflecting member 12 and the reflecting member 7 of FIG. 8B can switch the angles of the reflecting surfaces 12a and 7a within a predetermined angular range, which allows a first light L1 to be scanned within the first angular range and a second light L2 to be scanned within the second angular range.

FIGS. 8A and 8B are examples of the reflecting member 7 and the light direction changing unit 5, and other configurations are also possible. For example, the direction of the second light L2 can also be switched by rotating the table on which the distance measurement device 2 is mounted within a predetermined angular range. In this case, the table functions as the light direction changing unit 5.

Thus, in the first embodiment, when it is determined that the first light L1 emitted from the distance measurement device 2 has been emitted to the obstacle, the first light L1 is emitted to the reflecting member 7 and the second light L2 reflected by the reflecting member 7 is emitted to the object 6. This can reduce the range of the blind spot of the object 6 when detecting the position of the object 6 using light, and the position of the object 6 can be accurately detected even when there is an obstacle in the vicinity of the object 6. According to the present embodiment, it is not necessary to increase the number of sensors that project light, so that the equipment cost of the system 1 can be reduced.

### Second Embodiment

A second embodiment is for detecting the position of the object 6 by combining direct sensing and reflection sensing in the absence of the obstacle.

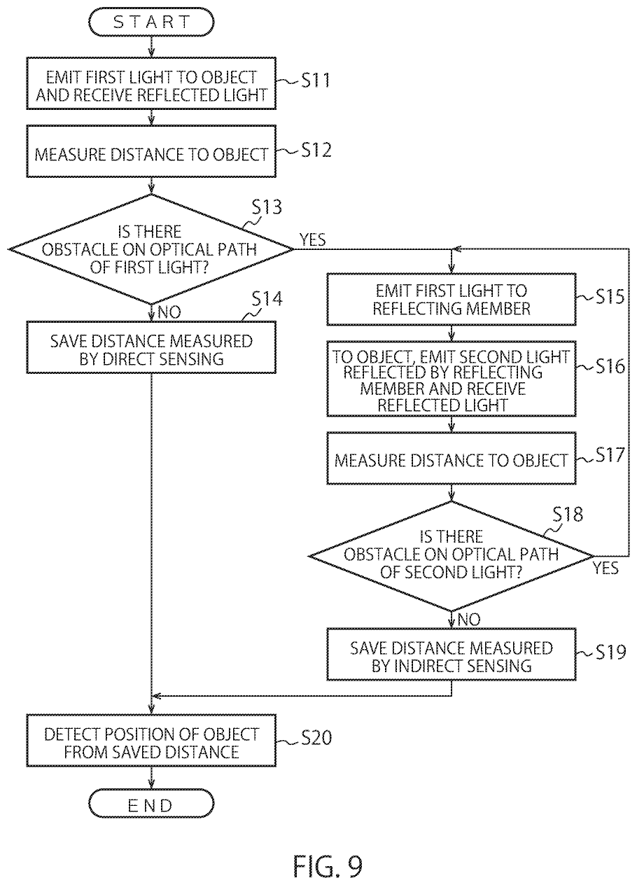

The block configuration of the system 1 according to the second embodiment is the same as that of FIG. 1 or 4. FIG. 9 is a flowchart illustrating the processing operation of the system 1 according to the second embodiment. In steps S11 to S13 of FIG. 9, the distance to the object 6 is measured by direct sensing, and the presence or absence of the obstacle is determined in accordance with the distance measured by the distance measurement device 2, as in steps S1 to S3 of FIG. 3. If the absence of the obstacle is determined, the measured distance is saved as the effective distance (step S14).

Next, in steps S15 to S18, the distance to the object 6 is measured by indirect sensing, and the presence or absence of the obstacle is determined in accordance with the distance measured by the distance measurement device 2, as in steps S5 to S8 in FIG. 3. If the absence of the obstacle is determined, the measured distance is saved as the effective distance (step S19).

Next, the position of the object 6 is detected in accordance with the distance information saved in steps S14 and S19.

If the presence of the obstacle is determined in step S13 by both direct and indirect sensing, it is desirable to repeat the processing of steps S15 to S18 such as by changing the direction of the second light L2 reflected by the reflecting member 7.

As described above, in the second embodiment, even when the absence of the obstacle is determined by the direct sensing, the result of distance measurement by indirect sensing as well as the result of distance measurement by direct sensing are taken into account to detect the position of the object 6, so that the position of the object 6 can be accurately detected.

### Third Embodiment

In a third embodiment, the reflecting member 7 has a plurality of reflecting surfaces 7a.

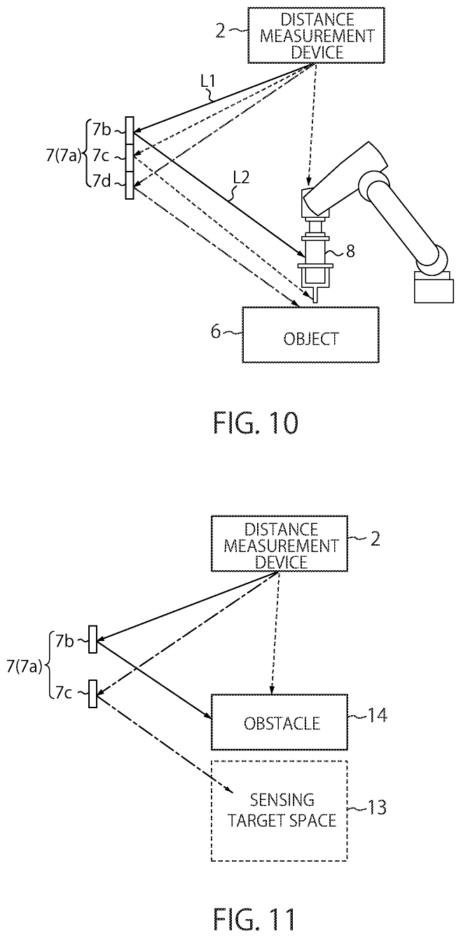

FIG. 10 is a diagram for explaining the technical characteristic of the system 1 according to the third embodiment. As illustrated in FIG. 10, the reflecting member 7 used for indirect sensing has a plurality of reflecting surfaces 7a. Although FIG. 10 illustrates an example in which the plurality of reflecting surfaces 7a is in close contact with each other, the plurality of reflecting surfaces 7a may be disposed separately.

The distance measurement device 2 can switch the direction of the first light L1 in the first angular range by the first optical scanning unit 9, and can project the first light L1 to the reflecting surface 7a selected from the plurality of reflecting surfaces 7a. As can be seen from FIG. 10, the plurality of reflecting surfaces 7a is located in different directions from the distance measurement device 2, so that the first light L1 emitted from the distance measurement device 2 to the plurality of reflecting surfaces 7a is reflected in different directions for each reflecting surface 7a. Therefore, the plurality of second light rays L2 reflected by the plurality of reflecting surfaces 7a travels in different directions to be incident on the object 6. For example, it is highly likely that, even when the second light L2 reflected by any one of the reflecting surfaces 7a is emitted to the obstacle, the second light L2 reflected by another reflecting surface 7a can be emitted to the object 6 without being emitted to the obstacle.

An example in which the reflecting member 7 has a first reflecting surface 7b, a second reflecting surface 7c, and a third reflecting surface 7d is described below. When performing the indirect sensing, the distance measurement device 2 first emits the first light L1 toward the first reflecting surface 7b. The first light L1 is reflected by the first reflecting surface 7b and becomes the second light L2 and proceeds toward the object 6. If the obstacle is irradiated with the second light L2, the light does not reach the distance measurement device 2, and the light direction changing unit 5 determines the presence of the obstacle.

Next, the distance measurement device 2 emits the first light L1 toward the second reflecting surface 7c. The second light L2 reflected by the second reflecting surface 7c travels toward the object 6. If the second light L2 is also emitted to the obstacle, the distance measurement device 2 emits the first light L1 toward the third reflecting surface 7d. If the second light L2, reflected by the third reflecting surface 7d, reaches the object 6 without being emitted to the obstacle, the distance measurement device 2 can use the third reflecting surface 7d to perform indirect sensing.

Thus, the third embodiment provides the plurality of reflecting surfaces 7a on the reflecting member 7, so that the distance measurement device 2 can switch the direction of the second light L2 reflected from the reflecting member 7 in the plurality of directions by selecting any one of the plurality of reflecting surfaces 7a to emit the first light L1. In the case of the third embodiment, it is not necessary for the light direction changing unit 5 to rotate the reflecting member 7, so that the configuration of the reflecting member 7 can be simplified.

### Fourth Embodiment

In a fourth embodiment, a range where the object 6 may exist is used as a sensing object space and its coordinates are registered in advance.

FIG. 11 is a diagram for explaining the technical characteristic of the system 1 according to the fourth embodiment. The sensing object space 13 illustrated in FIG. 11 is a region where the object 6 may exist and is designated, for example, by three-dimensional coordinates. The designated coordinate information is stored in a storage unit (not illustrated). When the type of the object 6 is changed, the coordinate information of the sensing object space 13 also changes.

The reflecting member 7 has a plurality of reflecting surfaces 7a as in the third embodiment. For simplification, FIG. 11 illustrates an example in which the reflecting member 7 has two reflecting surfaces 7a (hereinafter, referred to as a first reflecting surface 7b and a second reflecting surface 7c), but any number of the reflecting surfaces 7a may be used.

The distance measurement device 2 first performs distance measurement by direct sensing using the first light L1. The example of FIG. 11 illustrates an example in which the obstacle 14 exists on the optical path of the first light L1 by direct sensing. When the first light L1 is reflected by the obstacle 14 and the reflected light is received by the distance measurement device 2, the distance measurement device 2 receives the light in a shorter time than the reflected light from the sensing object space 13. Accordingly, the light direction changing unit 5 determines the presence of the obstacle 14 between the distance measurement device 2 and the sensing object space 13.

Next, the distance measurement device 2 performs distance measurement by indirect sensing using the second light L2. More specifically, the distance measurement device 2 irradiates the first reflecting surface 7b with the first light L1 and the reflected light is emitted as the second light L2 to the object 6. In the example of FIG. 11, the second light L2 reflected by the first reflecting surface 7b is reflected by the obstacle 14 and received by the distance measurement device 2. Since the distance measurement device 2 receives light in shorter time than the light reflected in the sensing object space 13, the light direction changing unit 5 determines that there is an obstacle 14 between the distance measurement device 2 and the sensing object space 13.

Next, the distance measurement device 2 irradiates the second reflecting surface 7c with the first light L1 and the reflected light is emitted as the second light L2 to the object 6. In the example of FIG. 11, the second light L2 reflected by the second reflecting surface 7c reaches the object 6 without being emitted to the obstacle 14. Since the distance measurement device 2 has comprehended the coordinate information of the sensing object space 13 in advance, it is determined that the second light L2 reflected by the second reflecting surface 7c is reflected by the sensing object space 13 and received, and then the distance measurement result is treated as the correct result.

As described above, in the fourth embodiment, the region in which the object 6 is present is set as the sensing object space 13, and its coordinate information is known in advance, thus facilitating identification as to whether the light received by the distance measurement device 2 is the reflected light from the sensing target space 13 or the reflected light from the obstacle 14.

### Fifth Embodiment

The fifth embodiment illustrates a specific configuration of the distance measurement device 2 according to the first to fourth embodiments.

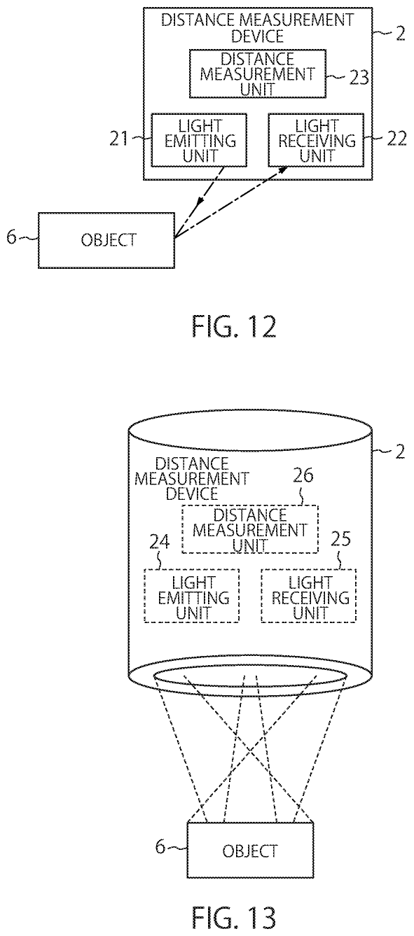

FIG. 12 is a block diagram illustrating a first example of the distance measurement device 2. The distance measurement device 2 of FIG. 12 measures the distance by the ToF method. The distance measurement device 2 of FIG. 12 includes a light emitting unit 21, a light receiving unit 22, and a distance measurement unit 23.

The light emitting unit 21 emits the first light L1 in a predetermined direction. The light emitting unit 21 intermittently transmits the pulsed first light L1 at predetermined intervals. Similarly to FIG. 4, the first optical scanning unit 9 may be provided to scan the first light L1 from the light emitting unit 21 within the first angular range.

The light receiving unit 22 receives the light from the object 6. More specifically, the light receiving unit 22 includes a photodetector, an amplifier, a light receiving sensor, an analog-to-digital (A/D) converter, and the like, which are not illustrated. The photodetector receives part of emitted laser light and converts it into an electric signal. The amplifier amplifies the electric signal output from the photodetector. The light receiving sensor converts the received laser light into an electric signal. The A/D converter converts the electric signal output from the light receiving sensor into a digital signal.

The distance measurement unit 23 measures the distance from the distance measurement unit 23 to the object 6 in accordance with a time difference between a light emitting timing of the first light L1 emitted by the light emitting unit 21 and a light receiving timing of the light received by the light receiving unit 22. When using laser light as the electromagnetic wave, the distance measurement unit 23 measures the distance in accordance with the following equation (6).

Distance=speed of light×(received timing of reflected light-transmitted timing)/2 (6)

The distance measurement device 2 may measure the distance by a method other than the ToF method illustrated in FIG. 12. FIG. 13 illustrates a second example of the distance measurement device 2. The distance measurement device 2 in FIG. 13 measures the distance by the pattern projection method. The distance measurement device 2 of FIG. 13 includes a light emitting unit 24 that emits light of a plurality of stripe patterns from a plurality of different directions toward the object 6, a light receiving unit 25 that receives the reflected light, and a distance measurement unit 26.

Since the light receiving pattern changes depending on the surface shape of the object 6 and the distance to the object 6, the distance measurement unit 26 can accurately detect the distance to the object 6.

The distance measurement device 2 in the system 1 according to the first to fourth embodiments described above can measure the distance by the ToF method of FIG. 12 or the pattern projection method of FIG. 13.

1. A system, comprising:
a distance measurement apparatus configured to emit a first light in a first direction toward an object or a second light in a second direction different from the first direction toward a reflection member, and to measure a distance to the object in accordance with a first reflected light provided by a reflection of the first light on the object or a second reflected light provided by reflections of the second light on both the reflection member and the object;
a position detector configured to detect a position of the object in accordance with the distance; and
a light direction controller configured to:
determine whether an obstacle exists on an optical path of the first direction;
control the distance measurement apparatus to emit the first light in the first direction, when the obstacle does not exist on the optical path; and
control the distance measurement apparatus to emit the second light in the second direction, when the obstacle exists on the optical path.

2. The system according to claim 1, wherein
the distance measurement device measures the distance to the object in accordance with the first reflected light, when determined that the obstacle does not exist on the optical path, and measures the distance to the object in accordance with the second reflected light when determined that the obstacle exists on the optical path.

3. The system according to claim 1, wherein
the distance measurement device measures the distance to the object in accordance with the first reflected light and the second reflected light when determined that the obstacle does not exist on the optical path, and measures the distance to the object in accordance with the second reflected light when determined that the obstacle exists on the optical path.

4. The system according to claim 1, further comprising:
a first optical scanner configured to scan a direction of the first light in a first angular range, wherein
the light direction controller determines whether the obstacle exists in the first angular range, and performs processing of emitting the second light to the object when determined that the obstacle exists in any direction within the first angular range.

5. The system according to claim 1, further comprising:
a second optical scanner configured to scan a direction of the second light in a predetermined second angular range, wherein
the light direction controller determines whether the obstacle exists within the second angular range, and
the light direction controller emits the second light to the object in a direction in which it is determined that the obstacle does not exist.

6. The system according to claim 5, wherein
the second optical scanner switches the direction of the second light within the second angular range until a predetermined number of times is reached while the light direction controller determines that the obstacle exists.

7. The system according to claim 1, further comprising:
a first optical scanner configured to scan a direction of the first light in a predetermined first angular range; and
a second optical scanner configured to scan a direction of the second light in a predetermined second angular range, wherein
the reflecting member includes a plurality of reflecting surfaces that reflects light,
the first optical scanner controls the direction of the first light to allow the light to be incident on one reflecting surface selected from the plurality of reflecting surfaces, when the light direction controller determines that the obstacle exists, and
the second optical scanner switches the direction of the second light depending on which of the plurality of reflecting surfaces is irradiated with the first light.

8. The system according to claim 1, wherein
the position detector comprises
a virtual image determiner configured to determine whether the position of the object detected by the position detector is a virtual image position in accordance with the distance measured by the distance measurement device and a position of the reflecting member, and
a real image converter configured to convert the virtual image position of the object to a real image position when it is determined that the position of the object is the virtual image position.

9. The system according to claim 8, wherein
a coordinate position Ar of the object is represented by Equation (1), where Av=(xi, yi, zi, 1) is coordinates of the virtual image position of the object detected by the position detector, H_{flip} represents a reflection conversion matrix for converting a virtual image into a real image, Hₘᵢᵣᵣₒᵣ represents a conversion matrix for moving coordinates of the reflecting member to a yz-plane, and H⁻¹ₘᵢᵣᵣₒᵣ represents an inversion matrix of the conversion matrix.
Aᵣ=HₘᵢᵣᵣₒᵣH_{flip}Hₘᵢᵣᵣₒᵣ⁻¹Aᵥ (1)

10. The system according to claim 9, wherein
when the reflecting surface of the reflecting member is disposed in a region parallel to a y-axis, the coordinate position of the reflecting surface is x=xm, a light emitting position is (xs, ys), the virtual image position of the object is (xt+2×xm, yt), and the real image position of the object is (xt, yt), a central angle θ of a scanning range of the reflecting member is represented by Equation (2).
$$θ = arctan ( \frac{yt - ys}{xt + 2 * xm - xs} ) \qquad ( 2 )$$

11. The system according to claim 1, wherein
the distance measurement device measures the distance to the object in accordance with a time difference between a light emitting timing and a light receiving timing of the reflected light at which the emitted light is reflected by the object.

12. The system according to claim 1, wherein
the distance measurement device measures the distance to the object by analyzing reflected pattern light that is emitted predetermined pattern light reflected by the object and received.

13. A method, comprising:
emitting a first light in a first direction toward an object or a second light in a second direction different from the first direction toward a reflection member, to measure a distance to the object by a distance measurement apparatus in accordance with a first reflected light provided by a reflection of the first light on the object or a second reflected light provided by reflections of the second light on both the reflection member and the object;
detecting a position of the object in accordance with the distance;
determining whether an obstacle exists on an optical path of the first direction;
controlling the distance measurement apparatus to emit the first light in the first direction, when the obstacle does not exist on the optical path; and
controlling the distance measurement apparatus to emit the second light in the second direction, when the obstacle exists on the optical path.

14. The method according to claim 13, further comprising:
measuring, when determined that the obstacle does not exist on the optical path, the distance to the object in accordance with the first reflected light; and
measuring, when determined that the obstacle exists on the optical path, the distance to the object in accordance with the second reflected light.

15. The method according to claim 13, further comprising:
measuring, when determined that the obstacle does not exist on the optical path, the distance to the object in accordance with the first reflected light and the second reflected light; and
measuring, when determined that the obstacle exists on the optical path, the distance to the object in accordance with the second reflected light.

16. The method according to claim 13, further comprising:
scanning a direction of the first light in a first angular range;
determining whether the obstacle exists in the first angular range; and
emitting, when determined that the obstacle exists in any direction within the first angular range, the second light to the object.

17. The method according to claim 13, further comprising:
scanning a direction of the second light in a predetermined second angular range;
determining whether the obstacle exists in the second angular range; and
emitting the second light to the object in a direction in which it is determined that the obstacle exists.

18. The method according to claim 17, further comprising:
switching, while it is determined that the obstacle exists, the direction of the second light within the second angular range until a predetermined number of times is reached.

19. The method according to claim 13, further comprising:
scanning a direction of the first light in a predetermined first angular range;
scanning a direction of the second light in a predetermined second angular range,
the reflecting member having a plurality of reflecting surfaces that reflects light;
controlling the direction of the first light to allow the light to be incident on one reflecting surface selected from the plurality of reflecting surfaces, when determined that the obstacle exists; and
switching the direction of the second light depending on which of the plurality of reflecting surfaces is irradiated with the first light.

20. The method according to claim 13, further comprising:
determining whether the position of the detected object is a virtual image position in accordance with the measured distance and a position of the reflecting member; and
converting the virtual image position of the object into a real image position when it is determined that the position of the object is the virtual image position.
